(19) United States
(12) Patent Application Publication
(10) Pub. No.: US 2008/0306747 A1
(43) Pub. Date: Dec. 11, 2008

(54) Method for Charging for a Service in a Communication Network

(76) Inventor: Walter Held, Geretsried (DE)

Correspondence Address: BELL, BOYD & LLOYD, LLP, P.O. BOX 1135, CHICAGO, IL, 60690, US

(21) Appl. No.: 10/583,687

(22) PCT Filed: Dec. 2, 2004
(86) PCT No.: PCT/EP2004/053226

§ 371 Date: Jun. 19, 2006

(30) Foreign Application Priority Data
Dec. 19, 2003 (EP) 03029455.7

(51) Int. Cl. G06Q 30/00

(52) U.S. Cl. 705/1

(57) ABSTRACT

The invention permits the operator of a stateless proxy, or application broker to offer a reliable trustworthy charging system which is accurate in definable intervals in a simple manner to registered application service suppliers, or registered clients, in which, during the provision of the service, the client and server are continuously provided with the charges applicable and the charging function, by means of an independent third party, including those from the independent third party.

### CROSS REFERENCE TO RELATED APPLICATIONS

This application is the US National Stage of International Application No. PCT/EP2004/053226, filed Dec. 2, 2004 and claims the benefit thereof. The International Application claims the benefits of European application No. 03029455.7 EP filed Dec. 19, 2003, both of the applications are incorporated by reference herein in their entirety.

### FIELD OF INVENTION

The present application relates to a method for charging for a service in a communication network.

### BACKGROUND OF INVENTION

In a packet-oriented communication network with service users (e.g. SIP clients), service providers (e.g. application servers) and a switching application broker (e.g. SIP proxy), which for the duration of the service relationship between a service user device (client) and an application server is not linked into this relationship (i.e. is not for example a stateful SIP proxy), it is impossible for the proxy to provide a reliable billing function for registered clients (clients and service providers).
Proxy remains in the communication relationship for the duration of the service relationship (stateful proxy), or
Billing runs separately between application server and client without including the proxy, i.e. the operator of the proxy is exclusively access provider. A complete bill from a single source even for services used can—if at all—only be achieved with major outlay in post processing−>distributed billing functions at the proxy operator and the application server provider. This solution requires on the one hand ensuring that the user of a service is also simultaneously client of proxy and server operator, and on the other hand requires the transfer of data to the central billing generator.

### SUMMARY OF INVENTION

The invention describes a method as to how, in this type of scenario with client, proxy (=application broker) and application server, billing which is reliable for all partners can be achieved, which in addition represents a value-added service for the provider of the basic service (operator of the proxy). This provider is thus in a position to offer his end customer reliable billing from a single source with packet-oriented services from the widest range of partner service providers. In this case the basic service provider can appear both as a simple broker of a service and also as an intermediate agent with “rebranding” (“rebranding” is taken in this case to mean the operator of the proxy offering a service of a partner service provider not under the original name of the service but under their own product name).

In the final analysis the purpose of this method is,
a) To bill registered clients with a credit account in real time with usage charges for requested and used services, or
b) To create for registered clients on a regular basis (e.g. monthly) a uniform overall bill for all services from different providers used.

The method ensures that
a) The client only pays for what he uses, and
b) The service provider is paid for his services.

In addition this method creates the conditions for the client to be able to be shown as an option, even while using the service in real time, what charges for the service have been accumulated, or for a pre-paid service, how much credit is still available.

This solution is based on a trusted billing function in which all partner components (client, proxy/application broker, application server) are linked in while the service is being used.
Client: Authenticates itself with the proxy and requests the service.
Proxy/application broker: Brokers the service and keeps account of the use of this service by the client.
Application server: Offers the service and informs the proxy with tickets about the creation and execution sequence of the service relationship between it and the client.

### BRIEF DESCRIPTION OF THE DRAWING

FIG. 1 describes for a realization variant of the invention the relationships of the partner components with each other and the basic execution sequence from the authentication of the client via the service request and service provision through to the billing.

### DETAILED DESCRIPTION OF INVENTION

After the client has authenticated itself with the aid of the proxy to the authentication-authorization-account server (AAA server) (1)/(2) it receives a billing reference (p1) from the proxy together with the information about where the application server is located (destination), which is generated by the proxy for exercising the billing function for the current service usage (3).
The client uses the information which it has received from the proxy to request the desired service from the application server (4). The latter acknowledges the service request to the client (5). The service relationship between client and application server is thus created.
After the service relationship between client and application server has been established, and for as long as the service is being used, the application server creates tickets at regular intervals (e.g. 1 per minute) which are sent to the billing function on the proxy (6). These tickets contain the reference p1, which allows the proxy efficient access to the billing table, and the reference s1, which the server itself has created and with which if necessary it can efficiently access its data later on a response from the proxy and can end an existing service relationship.
After receipt of a ticket (6) the proxy determines the client (IP address C1) on the basis of the reference p1 contained in the ticket and requests from the client an acknowledgement of this billing data (7) for each ticket received. If the acknowledgement has not been received after a specific time (e.g. 1 second), the request (7) is repeated once or twice more.
After receipt of the acknowledgement request the client verifies the ticket and where necessary sends an acknowledgement to the proxy (8).
After receipt of an acknowledgement from the client the proxy stores the ticket for subsequent billing creation (9) and informs the server that the client has acknowledged the ticket. In the case of a pre-paid customer the billing function on the proxy updates the customer's credit status.

### Special Cases for the Realization Variant of the Invention Described

Prepaid customer:

If the credit has fallen below a specific threshold the proxy informs the client that the credit is almost used up. This can be done for example at the next request for an acknowledgement for a ticket (7). If the credit is used up the proxy will delete an entry in the billing table and no longer accept further tickets from the application server for this customer and will send a negative acknowledgement for these tickets to the server, whereon the latter will if necessary end the service relationship to the client.
Negative acknowledgement by the client to a ticket request (7):

The proxy informs the application server that a ticket has been negatively acknowledged, in which case it returns the reference s1 to the application server. On the basis of the reference s1 the server is then able to end the service relationship to the client.
Ticket conformation from a client not received despite a number of requests:

The proxy informs the application server that it has been unable to receive an acknowledgement from the client for a ticket, in which case it returns the reference s1 to the application server. On the basis of the reference s1 the server is then able to end the service relationship to the client.
Timer t1 for billing table entry times out:

To ensure the validity of the billing table entry the proxy monitors the entry of the ticket from the server. As soon as a ticket (6) arrives the timer which has been set is reset. When the timer times out the entry in the table is deleted. Any subsequent tickets which might arrive from the server are negatively acknowledged.

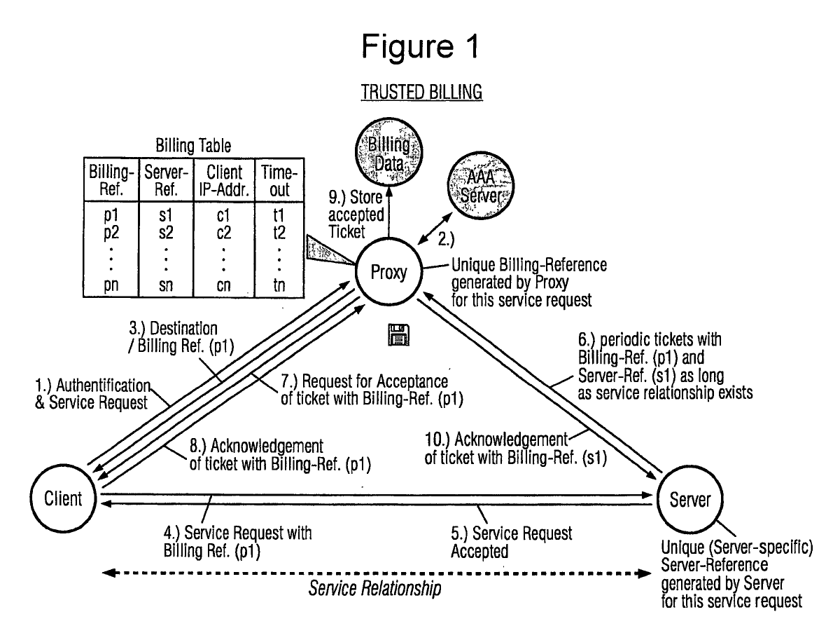

Remarks:
It should be noted that this method does not require the server and/or client to log off from the proxy when the service relationship is ended. Thus a billing ticket is always transmitted in advance to the client for the current billing interval. This ensures that the client does not make use of expensive services without paying for them by simply aborting the service before a billing interval expires in order to avoid being billed for the interval which has elapsed.
The monitoring timer t1 in the billing table must in any event be longer than the length of the billing interval which is agreed between client and application server. It must be long enough to avoid a lost (and therefore repeated by the server) ticket message to the proxy leading to the latter declaring the billing table entry invalid. Simultaneously however t1 must not be selected so that it is too long, in order to avoid for example denial-of-service attacks from malicious clients leading to a restriction of the billing table resources and in the final analysis to a non-availability of these services. A sensible value for t1 is 2-3 times the length of the billing interval. Since the length of the billing intervals of the individual service relationships (see FIG. 1) can be different, the length of the monitoring timer t1 is designed to be variable. As soon as the proxy receives a ticket from a server it uses the length of the billing interval specified within it and determines from this the length of t1, to monitor the receipt of the next ticket from the server for this service relationship. Until the receipt of the first ticket from the server a fixed initial uniform value for the billing table is used for this timer (e.g. 5 seconds).
Possible trust creation measures between client and application server: The conditions for the service relationship (length and costs of the 1st interval, length and costs of the subsequent intervals) are agreed between client and server. By selecting a short 1st interval and where necessary special conditions for this, it can be ensured that in cases where the service is not provided (e.g. server failure, SW error, incompatibility between client and server software) despite a service relationship being established, no disadvantage or only a slight disadvantage arises for the service user.
On failure of the billing function of the proxy, the application server, as a result of the missing acknowledgement to the ticket, can abort the service relationship to the client if necessary.
On failure of the client the client's billing account is not incorrectly debited by the server since the client is no longer in a position to acknowledge further ticket acknowledgement requests from the proxy (see special cases).
Functionality expandable at the client e.g. by
i. Accumulation of the billing messages transferred from the proxy and display of these charges at the terminal for billing monitoring in real time.
ii. Opportunity for end users to reject tickets as an option, e.g. on reaching a specific self-imposed limit of charges.

The invention can be summarized as follows. The method described allows the operator of a stateless proxy or application broker to offer in a simple manner registered application service providers and registered customers a reliable billing function accurate within definable intervals and trustworthy, by client and server constantly communicating in the background at regular intervals during service provision via an independent third party (proxy) about the charges arising for them and by the billing function also being provided by the independent third party.

### Examples of Inventive Applications

Information services
Video services
Supplementary telephone services, such as Conferences via conference servers
Mailbox interrogations
Anonymous billing for gateways which are activated from the public Internet

1.-14. (canceled)

15. A method for using a proxy device to charge for a service in a communication network, comprising:
receiving a request for a service from a client;
performing an authentication of the client in response to receiving the service request;
sending the client a reference to an application server in response to a successful authentication, the application server providing the requested service;
receiving from the application server a ticket having information relating the charges for the service;
sending a request for a charge acknowledgement to the client in response the receiving the ticket;
receiving a charge acknowledge response from the client; and
performing a charge registration for the ticket in response to the charge acknowledgement response.

16. The method in accordance with claim 15, wherein the charges occur during the use of the service.

17. The method in accordance with claim 15, wherein the charges occur before the use of the service.

18. The method in accordance with claim 15, wherein the charge registration includes updating a credit status or charge status of the client.

19. The method in accordance with claim 15, wherein the charge registration includes storing the ticket for a subsequent billing.

20. The method in accordance with claim 15, further comprising notifying the client of charges included for the charge registration.

21. A method for using a application server to charge for a service in a communication network, comprising:
receiving a service request from a client, the service request including a reference to a proxy device;
creating a ticket in response to the service request, the ticket including information about the charges due to the client for the service;
sending a service acceptance to the client, whereby a service relationship is established between the application server and the client;
sending the ticket to the proxy device;
receiving a message from the proxy device indicating if the ticket was acknowledged by the client; and
maintaining the service relationship for the client if the message indicates the ticket was positively acknowledged.

22. The method in accordance with claim 21, wherein the ticket indicates the charges occur during the use of the service.

23. The method in accordance with claim 21, wherein the ticket indicates the charges occur before the use of the service.

24. The method in accordance with claim 21, further comprising ending the service relationship to the client if the message indicates that the ticket was negatively acknowledged

25. The method in accordance with claim 21, further comprising ending the service relationship to the client if the message indicates that ticket was not acknowledged.

26. The method in accordance with claim 21, further comprising ending the service relationship to the client if proxy device notifies the server that a sufficient credit is not available in the case of a pre-paid client.

27. A method of use of a client in order to be charged for a service in a communication network, comprising:
sending a service request to a proxy device;
receiving a reference to the requested service from the proxy device;
setting up a service relationship to an application server based on the reference;
receiving from the proxy device a billing message having charge information for the service; and
responding to the proxy with a billing response.

28. The method in accordance with claim 27, further comprising displaying the charges to an end user.

29. The method in accordance with claim 28, wherein the charges are displayed in real time.

30. The method in accordance with claim 28, further comprising receiving a response from the end user pertaining to the charges.

31. A method for charging for a service in a communication network, comprising:
sending a service requesting to a proxy device by a client;
performing an authentication of the client via the proxy device;
sending a service request response to the client by the proxy device in response to a successful authentication, the response having a service reference;
communicating a proxy device reference to an application server by the client;
establishing a service relationship between the application server and the client based on the service reference;
creating a ticket by the application server;
sending the created ticket to the proxy device, the created ticket having billing information;
sending a request to the client to acknowledge the billing information, the request sent by the proxy device; and
including the ticket in a charge registration action by the proxy device if the proxy device receives an acknowledgment to the billing information by the client.

32. The method according to claim 31, further comprising:
forwarding the acknowledgement of the billing information to the application server; and
maintaining the service relationship if the billing information is positively acknowledged.

33. The method according to claim 31, further comprising:
forwarding the acknowledgement of the billing information to the application server; and
ending the service relationship if the billing information is negatively acknowledged.
